(19) United States
(12) Patent Application Publication
(10) Pub. No.: US 2018/0039468 A1
(43) Pub. Date: Feb. 8, 2018

(54) METHOD, SYSTEM, AND NON-TRANSITORY COMPUTER-READABLE STORAGE MEDIUM FOR PROVIDING CONTENT BY USING DIGITAL SIGNAGE

(71) Applicants: Jeung Ho KIM, Seoul (KR); KNOWCK CO., LTD., Seoul (KR)

(72) Inventor: Jeung Ho KIM, Seoul (KR)

(21) Appl. No.: 15/788,024

(22) Filed: Oct. 19, 2017

Related U.S. Application Data
(63) Continuation of application No. PCT/KR2015/012924, filed on Nov. 30, 2015.

(30) Foreign Application Priority Data
Apr. 22, 2015 (KR) 10-2015-0056504

(51) Int. Cl. G06F 3/147; G06F 17/21

(52) U.S. Cl. CPC G06F 3/147; G06F 17/212

(57) ABSTRACT

A method for providing content by using digital signage includes performing a preprocessing operation of dividing content collected through a communication network into at least one content unit; and determining a provision pattern of the at least one content unit with reference to at least one of situation information of digital signage which will provide the content and setup information input by a manager who manages the content and reconstructing the content on the basis of the determined provision pattern, wherein the situation information includes at least one of information about specification of a content playing device provided in the digital signage, information about a place where the digital signage is installed, information about types of people to be provided with content through the digital signage, the setup information includes at least one of information about a playback time or playback time zone assigned to the content and a layout applied to the content, and in the reconstructing of the content, it is determined whether the at least one content unit is to be included in the reconstructed content and at least one of a size, a combination, or a playback time of a content unit determined to be included in the reconstructed content is determined to determine the provision pattern.

### TECHNICAL FIELD

The present disclosure relates to a method, a system, and a non-transitory computer-readable storage medium for providing content by using digital signage.

### BACKGROUND

Recently, content providing media have varied in form and content providing methods have been automated. For example, outdoor advertising has adopted a modern way of providing advertising content through flexible media such as a LED electronic display board or a LCD TV, departing from a traditional way of providing advertising content through fixed print media such as paper or film.

So-called digital signage is a communication tool which can be used in marketing, advertising, and training by an advertiser to induce customer experience and refers to a digital image display device configured to provide not only ordinary broadcasting content but also advertising content intended by an advertiser in public places such as airports, hotels, hospitals, and the like, and it is also referred to as a digital signboard or digital information display (DID). The digital signage is equipped with a processor and a memory and can be moved freely and can vividly display various content and thus is being used for a variety of uses such as media for promotion, customer service, guidance, and the like in department stores, subways, bus stops, and the like. Further, the digital signage provides not only advertising content but also various kinds of content for other purposes.

However, each digital signage is different in display screen size and resolution and people to be provided with content vary depending on a place where the digital signage is installed. Therefore, according to a conventional technology which requires a manager him/herself to processor edit content to be displayed through the digital signage, the manager needs to process or manage the size, format, context, etc. of content for each digital signage all the time, which causes inconvenience and inefficiency.

Accordingly, there is a need for a technology of efficiently providing content through the digital signage.

### DISCLOSURE OF THE INVENTION

### Problems to be Solved by the Invention

The present disclosure is conceived to solve all the above-described problems of the conventional technology.

The present disclosure is conceived to perform a preprocessing operation of dividing content collected through a communication network into at least one content unit and reconstruct the content by determining a provision pattern of the at least one content unit with reference to at least one of situation information of digital signage which will provide the content and setup information input by a manager who manages the content and thus to automatically reconstruct the format or context of the content provided through the digital signage to be suitable for situations.

### Means for Solving the Problems

Example embodiments of the present disclosure are as follows to meet the aforementioned requirements.

In one example embodiment, A method for providing content by using digital signage includes performing a preprocessing operation of dividing content collected through a communication network into at least one content unit; and determining a provision pattern of the at least one content unit with reference to at least one of situation information of digital signage which will provide the content and setup information input by a manager who manages the content and reconstructing the content on the basis of the determined provision pattern, wherein the situation information includes at least one of information about specification of a content playing device provided in the digital signage, information about a place where the digital signage is installed, information about types of people to be provided with content through the digital signage, the setup information includes at least one of information about a playback time or playback time zone assigned to the content and a layout applied to the content, and in the reconstructing of the content, it is determined whether the at least one content unit is to be included in the reconstructed content and at least one of a size, a combination, or a playback time of a content unit determined to be included in the reconstructed content is determined to determine the provision pattern.

In another example embodiment, a system for providing content by using digital signage includes a content preprocessing unit that performs a preprocessing operation of dividing content collected through a communication network into at least one content unit; and a content reconstruction unit that determines a provision pattern of the at least one content unit with reference to at least one of situation information of digital signage which will provide the content and setup information input by a manager who manages the content and reconstructs the content on the basis of the determined provision pattern, wherein the situation information includes at least one of information about specification of a content playing device provided in the digital signage, information about a place where the digital signage is installed, information about types of people to be provided with content through the digital signage, the setup information includes at least one of information about a playback time or playback time zone assigned to the content and a layout applied to the content, and the content reconstruction unit determines whether the at least one content unit is to be included in the reconstructed content and determines at least one of a size, a combination, or a playback time of a content unit determined to be included in the reconstructed content to determine the provision pattern.

In still another example embodiment, a non-transitory computer-readable recording medium having stored thereon computer-executable instructions that, in response to execution, cause other method, other system and the method to be performed.

### Effects of the Invention

According to the present disclosure, it is possible to automatically reconstruct the format or context of content provided through digital signage to be suitable for situations and thus possible to achieve the effect of efficiently providing content through digital signage.

Further, according to the present disclosure, it is possible to process or edit each of content units constituting content and thus possible to achieve the effect of more flexibly and variously reconstructing content provided through digital signage.

### BRIEF DESCRIPTION OF THE DRAWINGS

FIG. 1 is a diagram illustrating a schematic configuration of an entire system for providing content by using digital signage in accordance with an exemplary embodiment of the present disclosure.

FIG. 2 is a diagram illustrating an internal configuration of a content providing system 200 in accordance with an exemplary embodiment of the present disclosure in detail.

FIG. 3 is a diagram illustrating an exemplary process of reconstructing content in accordance with an exemplary embodiment of the present disclosure.

### EXPLANATION OF REFERENCE NUMERALS

100: communication network
200: content providing system
210: content preprocessing unit
220: content reconstruction unit
230: communication unit
240: control unit
300: manager device
400: digital signage

### MODE FOR CARRYING OUT THE INVENTION

Detailed descriptions of the present disclosure will be made with reference to the accompanying drawings illustrating specific embodiments of the present disclosure as examples. These embodiments will be described in detail such that the present disclosure can be performed by those skilled in the art. It should be understood that various embodiments of the present disclosure are different, but are not necessarily mutually exclusive. For example, a specific shape, structure, and characteristic of an embodiment described herein may be implemented in another embodiment without departing from the spirit and scope of the present disclosure. In addition, it should be understood that a position or an arrangement of each component in each embodiment may be changed without departing from the spirit and scope of the present disclosure. Accordingly, there is no intent to limit the present disclosure to the detailed descriptions to be described below, and the scope of the present disclosure is defined by the appended claims and encompasses all equivalents that fall within the scope of the appended claims. Like reference numerals in the drawings refer to the same or like components throughout various aspects.

Hereinafter, in order to easily perform the present disclosure by those skilled in the art, exemplary embodiments of the present disclosure will be described in detail with reference to the accompanying drawings.

### Configuration of Entire System

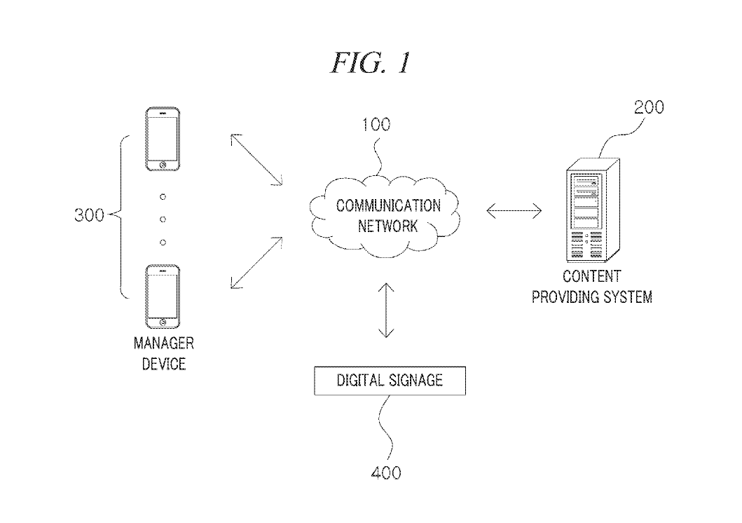

FIG. 1 is a diagram illustrating a schematic configuration of an entire system for providing content by using digital signage in accordance with an exemplary embodiment of the present disclosure.

As illustrated in FIG. 1, the entire system in accordance with an exemplary embodiment of the present disclosure may include a communication network 100, a content providing system 200, a manager device 300, and digital signage 400.

Firstly, the communication network 100 in accordance with an exemplary embodiment of the present disclosure may be configured regardless of communication modes such as wired and wireless communication, and may be configured as various types of communication networks such as Local Area Network (LAN), Metropolitan Area Network (MAN), Wide Area Network (WAN), and the like. Desirably, the communication network 100 described herein may be publicly known Internet or World Wide Web (WWW). However, the communication network 100 is not necessarily limited thereto, and may include at least part of publicly known wired or wireless data communication networks, telephone networks, or wired or wireless television communication networks.

The content providing system 200 in accordance with an exemplary embodiment of the present disclosure may perform a preprocessing operation of dividing content collected through a communication network into at least one content unit and reconstruct the content by determining a provision pattern of the at least one content unit with reference to at least one of situation information of digital signage which will provide the content and setup information input by a manager who manages the content and thus to automatically reconstruct the format or context of the content provided through the digital signage to be suitable for situations.

The configuration and function of the content providing system 200 according to the present disclosure will be discussed in detail in the following detailed description. Meanwhile, the content providing system 200 has been described above, but such a description is provided by way of illustration only. It is obvious to those skilled in the art that at least some of the functions or components required for the content providing system 200 may be implemented in the manager device 300 or the digital signage 400 or included in the manager device 300 or the digital signage 400 if necessary.

Then, the manager device 300 in accordance with an exemplary embodiment of the present disclosure is a digital device that enables the manger to access the content providing system 200 and then perform communication, and any digital device including a memory unit and a microprocessor with computational capability, for example, a smart phone, a tablet PC, a desktop computer, a notebook computer, a workstation, a PDA, a web pad, a mobile phone, or the like, can be adopted as the manager device 300 according to the present disclosure.

Further, in accordance with an exemplary embodiment of the present disclosure, the manager device 300 may include an application (not illustrated) that supports the manager to input various kinds of setup information or situation information of digital signage required to reconstruct content. Such an application may be downloaded from the content providing system 200 or publicly known web server (not illustrated). Meanwhile, the nature of the program module may be generally similar to that of a content preprocessing unit 210, a content reconstruction unit 220, a communication unit 230, and a control unit 240 of the content providing system 200 which will be described later. Herein, at least a part of the application may be replaced with a hardware or firmware device that may perform a substantially equal or equivalent function, as necessary.

In accordance with an exemplary embodiment of the present disclosure, the digital signage 400 may receive content reconstructed by the content providing system 200 and then provide the content to people. Specifically, the digital signage 400 may include a display device such as a LCD panel and an OLED, and may further include a speaker for sound output.

In accordance with an exemplary embodiment of the present disclosure, the digital signage 400 may be installed in public places such as department stores, subways, bus stops, airports, hotels, hospitals, and the like, which are enumerated only as examples, and the places to install the digital signage 400 of the present disclosure are not necessarily limited thereto.

Meanwhile, in accordance with an exemplary embodiment of the present disclosure, information about specification of the digital signage 400 and information about an identifier for a place where the digital signage 400 is installed may be provided as situation information of the digital signage 400 to the content providing system 200.

### Configuration of Content Providing System

Hereinafter, an internal configuration and a function of each component of the content providing system 200 according to the present disclosure will be described.

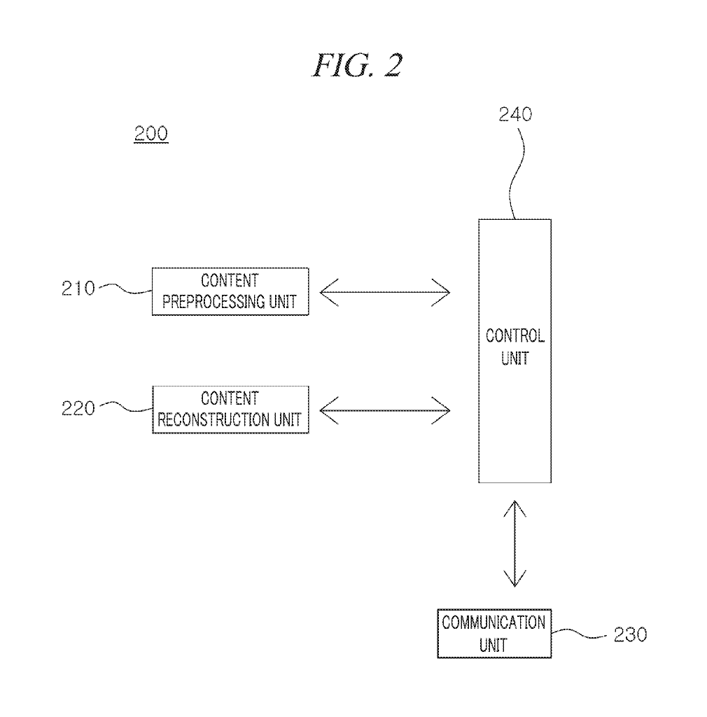

FIG. 2 is a diagram illustrating an internal configuration of the content providing system 200 in accordance with an exemplary embodiment of the present disclosure in detail.

As illustrated in FIG. 2, the content providing system 200 in accordance with an exemplary embodiment of the present disclosure may include the content preprocessing unit 210, the content reconstruction unit 220, the communication unit 230, and the control unit 240. In accordance with an exemplary embodiment of the present disclosure, at least some of the content preprocessing unit 210, the content reconstruction unit 220, the communication unit 230, and the control unit 240 may be program modules that communicate with the manager device 300. The program modules may be included in the content providing system 200 in the form of an operating system, an application program module, or other program modules and may be physically stored in various publicly known storage devices. Further, the program modules may also be stored in a remote storage device that may communicate with the content providing system 200. Meanwhile, the program modules may encompass a routine, a subroutine, a program, an object, a component, a data structure and the like for performing a specific task or executing a specific abstract data type as will be described below according to the present disclosure, but may not be limited thereto.

Firstly, in accordance with an exemplary embodiment of the present disclosure, the content preprocessing unit 210 may perform a function of diving (i.e., separating) content collected through the communication network into at least one content unit. To this end, the content preprocessing unit 210 in accordance with an exemplary embodiment of the present disclosure may use publicly known content recognition technologies, content extraction technologies, content processing technologies, and the like.

Herein, the at least one content unit included in the content is a component constituting the content, and needs to be understood as a concept including all kinds of content which can be separated from another content unit and independently processed, edited, or combined. For example, the content unit according to the present disclosure may be specified by a text, an image, video data, audio data, a widget, an application, and the like. However, a configuration of the content unit according to the present disclosure is not necessarily limited to those enumerated above and can be changed freely as long as the objects of the present disclosure can be achieved.

In accordance with an exemplary embodiment of the present disclosure, the content reconstruction unit 220 may perform a function of reconstructing the content by determining a provision pattern of the at least one content unit with reference to at least one of situation information of the digital signage 400 which will provide the content and setup information input by the manager who manages the content. Specifically, the content reconstruction unit 220 in accordance with an exemplary embodiment of the present disclosure may determine a content unit to be included in the reconstructed content among the at least one content unit included in the collected original content and determine a size, a combination, or a playback time of the content unit to be included in the reconstructed content and thus reconstruct the content to be provided through the digital signage 400.

Herein, in accordance with an exemplary embodiment of the present disclosure, the situation information of the digital signage 400 which serves as reference in determining a provision pattern of the at least one content unit may include information about specification such as resolution or size of a display device provided in the digital signage 400 and the number or volume of speakers, information about a place where the digital signage 400 is installed, information about types of people to be provided with content through the digital signage 400, and the like.

Further, in accordance with an exemplary embodiment of the present disclosure, the setup information input by the manager who manages the content may include information about a playback time or playback time zone assigned to the content, a layout applied to the content, and the like.

Meanwhile, the content reconstruction unit 220 in accordance with an exemplary embodiment of the present disclosure may reconstruct the content by adding additional content units determined suitable for the content to the content unit already included in the content collected from the user device 300 or a server (not illustrated).

Meanwhile, the content reconstruction unit 220 in accordance with an exemplary embodiment of the present disclosure may further perform a function of providing a manager interface that supports the manager to input the setup information for content reconstruction and enables the manager to check the reconstructed content being displayed.

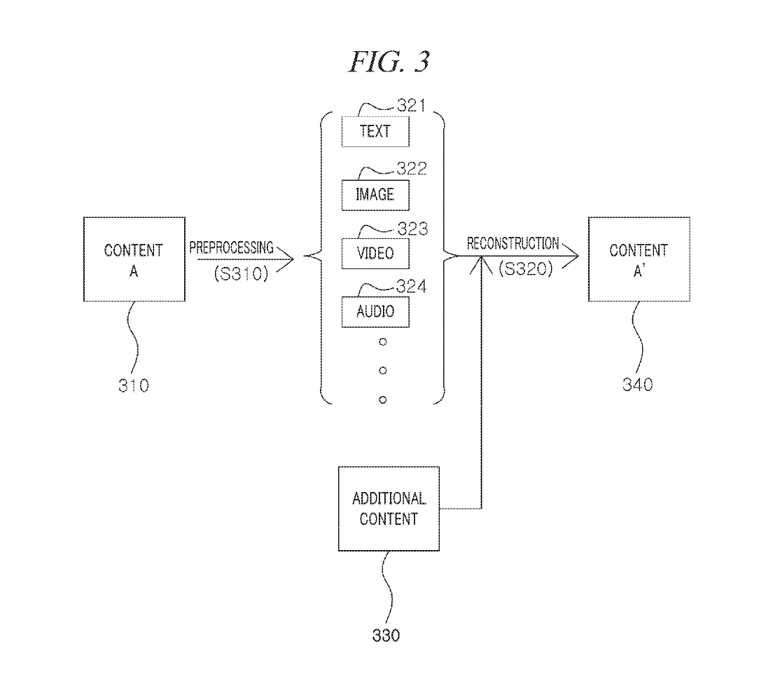

FIG. 3 is a diagram illustrating an exemplary process of reconstructing content in accordance with an exemplary embodiment of the present disclosure.

Referring to FIG. 3, content A 310 may be divided into multiple content units such as a text 321, an image 322, audio data 323, video data 324, a widget (not illustrated), and an application (not illustrated), and these divided content units 321 to 324 may be stored in a predetermined database (not illustrated). Referring to FIG. 3, at least some of the content units 321 to 324 divided and stored as described above may be reconstructed depending on a provision pattern which is determined on the basis of the situation information of the digital signage 400 or the setup information input by the manager, and, thus, reconstructed content A′ 340 to be provided on the digital signage 400 can be generated. In this case, the reconstructed content A′ 340 may include additional content 330 as well as the content units 321 to 324 already included in the content A 310.

For example, it can be assumed that advertising content including a text and video data is provided on the digital signage 400. In this case, according to an exemplary embodiment of the present disclosure, the font size of the text and the resolution of the video data which are content units constituting the advertising content may be adjusted to be suitable for specification of the display screen of the digital signage 400, and additional content such as URL information of a website of an advertiser may be added to the content units already included in the original advertising content. Therefore, in accordance with an exemplary embodiment of the present disclosure, the original advertising content may be reconstructed as advertising content including the text with the adjusted font size, the video data with the adjusted resolution, and the website URL address.

The communication unit 250 in accordance with an exemplary embodiment of the present disclosure may perform a function of enabling data transmission/reception to/from the content providing system 200.

The control unit 260 in accordance with an exemplary embodiment of the present disclosure may perform a function of controlling the flow of data among the content preprocessing unit 210, the content reconstruction unit 220, and the communication unit 230. That is, the control unit 260 according to the present disclosure may control the content preprocessing unit 210, the content reconstruction unit 220, and the communication unit 230 to perform their own functions, respectively, by controlling the data flow from/to the outside of the content providing system 200 or the data flow among the components of the content providing system 200.

The above-described embodiments of the present disclosure may be implemented in the form of a program command that can be performed through various computer components, and may be recorded on a computer-readable storage medium. The computer-readable storage medium may include a program command, a data file, and a data structure individually or a combination thereof. The program command recorded in the computer-readable storage medium may be specially designed and configured for the present disclosure, or may be known to those skilled in a computer software field to be used. Examples of the computer-readable storage medium include a magnetic medium such as a hard disk, a floppy disk, and a magnetic tape, an optical medium such as a CD-ROM and a DVD, a magneto-optical medium such as a floptical disk, and a hardware device such as a ROM, a RAM, and a flash memory, that are specially configured to store and perform program commands. Examples of the program commands may include a machine code generated by a compiler and a high-level language code that can be executed in a computer using an interpreter. The hardware device may be configured as at least one software-module in order to perform the operations of the present disclosure, and vice versa.

While the present disclosure has been described with reference to specific details, such as detailed components, specific embodiments, and drawings, these are only examples to facilitate the overall understanding of the present disclosure and the present disclosure is not limited thereto. It will be understood by those skilled in the art that various modifications and changes can be made from the descriptions above.

Therefore, the spirit of the present disclosure is defined not by the detailed description of the invention, but by the appended claims, and encompasses all modifications and equivalents that fall within the scope of the appended claims.

1. A method for providing content by using digital signage, comprising:
performing a preprocessing operation of dividing content collected through a communication network into at least one content unit; and
determining a provision pattern of the at least one content unit with reference to at least one of situation information of digital signage which will provide the content and setup information input by a manager who manages the content and reconstructing the content on the basis of the determined provision pattern,
wherein the situation information includes at least one of information about specification of a content playing device provided in the digital signage, information about a place where the digital signage is installed, information about types of people to be provided with content through the digital signage,
the setup information includes at least one of information about a playback time or playback time zone assigned to the content and a layout applied to the content, and
in the reconstructing of the content, it is determined whether the at least one content unit is to be included in the reconstructed content and at least one of a size, a combination, or a playback time of a content unit determined to be included in the reconstructed content is determined to determine the provision pattern.

2. The method for providing content by using digital signage of claim 1,
wherein the at least one content unit is specified by at least one of a text, an image, video data, audio data, a widget, and an application.

3. The method for providing content by using digital signage of claim 1,
wherein in the reconstructing of the content, the reconstructed content further includes additional content as well as the collected content.

4. The method for providing content by using digital signage of claim 1,
wherein in the reconstructing of the content, a manager interface that supports the manager to input the setup information and enables the manager to check the reconstructed content being displayed is provided.

5. A non-transitory computer-readable storage medium that stores a computer program configured to execute the method of claim 1.

6. A system for providing content by using digital signage, comprising:
a content preprocessing unit that performs a preprocessing operation of dividing content collected through a communication network into at least one content unit; and
a content reconstruction unit that determines a provision pattern of the at least one content unit with reference to at least one of situation information of digital signage which will provide the content and setup information input by a manager who manages the content and reconstructs the content on the basis of the determined provision pattern,
wherein the situation information includes at least one of information about specification of a content playing device provided in the digital signage, information about a place where the digital signage is installed, information about types of people to be provided with content through the digital signage,
the setup information includes at least one of information about a playback time or playback time zone assigned to the content and a layout applied to the content, and
the content reconstruction unit determines whether the at least one content unit is to be included in the reconstructed content and determines at least one of a size, a combination, or a playback time of a content unit determined to be included in the reconstructed content to determine the provision pattern.
